(19) United States
(12) Patent Application Publication
(10) Pub. No.: US 2006/0079122 A1
(43) Pub. Date: Apr. 13, 2006

(54) Cable for connecting devices to a computer via a keyboard

(76) Inventor: Edgar Matias, Rexdale (CA)

Correspondence Address: PERRY & PARTNERS, 1300 YONGE STREET, SUITE 500, TORONTO, ON, M4T-1X3, CA

(21) Appl. No.: 10/959,965

(22) Filed: Oct. 8, 2004

(51) Int. Cl. H01R 11/00

(52) U.S. Cl. 439/502

(57) ABSTRACT

An improved cable is set forth for connecting a keyboard and at least one peripheral device to a computer. The standard cable from keyboard to computer incorporates an extender cable leading directly to a port connector on the keyboard. This inexpensive and simple solution can be used to position ports within easy reach of the user, while minimizing the manufacturing cost and design complexity of the keyboard.

### BACKGROUND OF THE INVENTION

1. Field of the Invention

The present invention is directed to computers, and more particularly to an improved cable for connecting one or more peripheral devices to a computer via one or more USB connectors on a keyboard.

2. Description of the Related Art

It is well known in the computer arts to incorporate USB hubs into accessory devices that are within easy reach of the user, such as: keyboards, monitors, or stand-alone USB hubs. More particularly, it is known in the art to plug a peripheral into a hub on a keyboard, as a convenient alternative to reaching through a tangle of wires behind the computer, in order to plug the peripheral directly into a port on the computer.

For example, U.S. Pat. Nos. D421,976 and D454,566 each disclose a keyboard with a single cable connected to a 3-port USB hub incorporated into the keyboard electronics. One port of the hub is connected to the keyboard controller, and the other two ports are available to connect to accessory USB devices, via connectors conveniently positioned on the left and right sides of the keyboard.

This convenience comes at a price, and has limitations. Keyboards with built-in hubs are more expensive to manufacture, due to the additional cost of the electronics required for the hub. Also, the hub is powered by the port to which it is connected, which must share that power with all of the devices that are plugged into it. If any of the devices have higher power requirements (as is the case with most high-speed USB 2.0 devices) there may not be enough power available such that those devices will not function.

In order to minimize cost, the hubs used in USB keyboards are normally of slower communication speed (e.g. USB 1.1 hubs). This speed limitation renders such hubs useless for connecting to certain devices, such as high-capacity external hard drives, which require USB 2.0. The loading of large files using USB 1.1 would take 10 to 20 times longer than with USB 2.0, a delay that most users would not tolerate.

U.S. Pat. No. D490,812 sets forth a keyboard similar to those discussed above, but with the USB port connectors positioned close together, near the keyboard cable exit hole. This allows the port connectors, hub electronics, and keyboard controller all to be mounted on the same PCB. Although the placement of the USB connectors makes it less expensive to manufacture, the port placement is not as convenient as on the two keyboards disclosed in prior art U.S. Pat. Nos. D421,976 and D454,566.

Other prior art approaches are set forth in U.S. Pat. No. 6,449,142 and U.S. Patent Application 20020109675.

### SUMMARY OF THE INVENTION

According to the present invention, an improved cable is set forth for connecting devices to computers. Instead of (or in addition to) a USB hub, the keyboard's cable incorporates an extender cable leading directly to a port connector on the keyboard. This inexpensive and simple solution can be used to position ports within easy reach of the user, while minimizing the manufacturing cost and design complexity of the keyboard.

### BRIEF DESCRIPTION OF THE DRAWINGS

A detailed description of the invention is set forth herein below, with reference to the following drawing, in which:

FIG. 1 shows a preferred embodiment of the keyboard cable according to the present invention.

FIG. 2 is a schematic illustration showing the keyboard cable of FIG. 1 in use connected to a computer, keyboard and peripheral device.

FIG. 3 is a top view of the cable of FIG. 1 connected to the keyboard of FIG. 2.

FIG. 4 is a detailed view of a pair of plugs at one end of the cable for connection to the computer and a port on the keyboard to which the peripheral device may be connected.

### DETAILED DESCRIPTION OF THE PREFERRED EMBODIMENTS

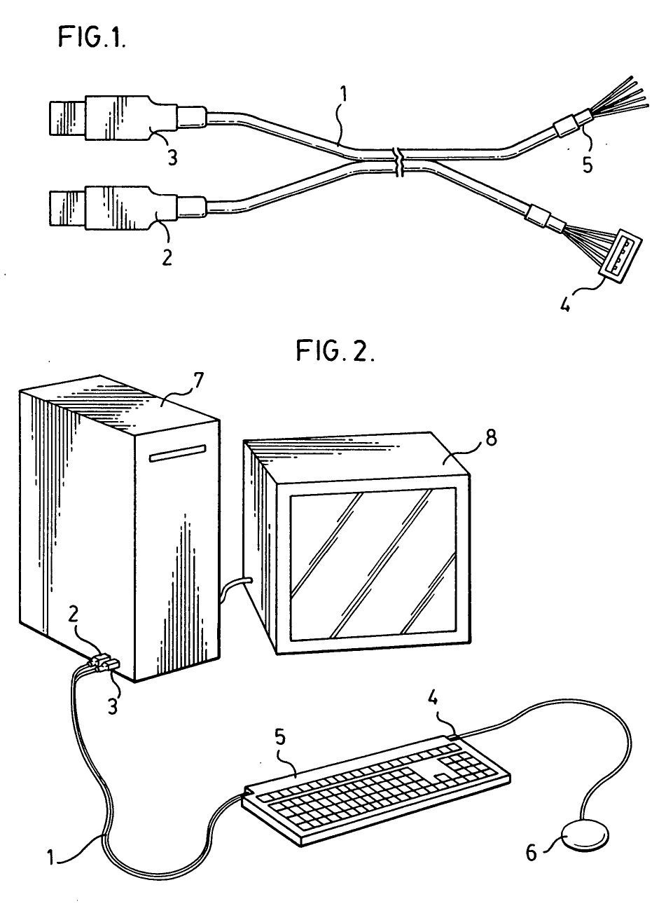

FIG. 1 shows an improved keyboard cable according to the preferred embodiment, having two sets of wires that act individually as separate USB cables. One set of wires is provided with a USB plug (2) terminating in a port connector (4), and the other wire set is provided with a USB plug (3) terminating in wiring (5).

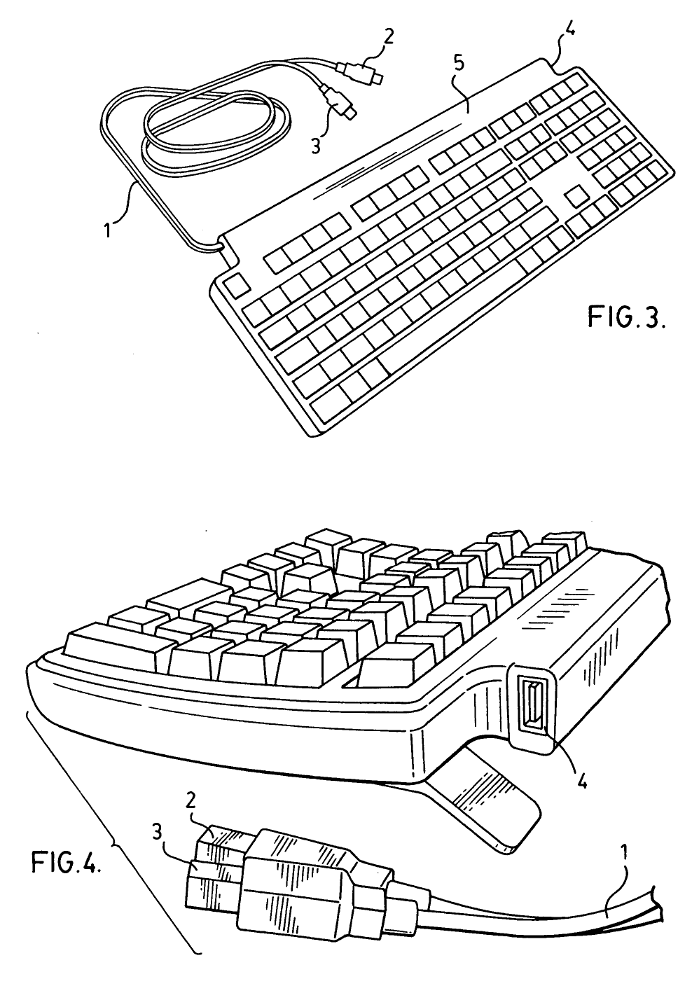

As shown in FIGS. 2 and 3, the cable (1) is incorporated into a keyboard by connecting the keyboard wiring (5) to conventional keyboard electronics (not shown) within the keyboard, while port connector 4 is incorporated into the keyboard at any convenient location. The keyboard electronics also may, but do not necessarily, incorporate a USB hub (e.g. typically a low-cost USB 1.1 hub). USB plugs (2) and (3) are connected to standard USB ports on a computer (7) having a monitor (8). A peripheral device (6) may be connected to the USB port connector (4), such that the cable (1) functions as an extension cable between the peripheral device (6) and the computer (7). This is electrically equivalent to plugging the USB accessory (6) directly into a USB port on the computer (7).

As discussed above, the port connector (4) may be positioned at any convenient location on the keyboard. For example, as shown in FIG. 4, the port connector (4) may be positioned opposite to the entry location of the cable (1) into the keyboard. Locations for incorporating the connector (4) include the locations where USB ports have been incorporated into keyboards, as set forth in the prior art references discussed above.

The cable (1) according to the present invention effectively provides a USB 2.0 connection through a keyboard, without incorporating an expensive USB 2.0 hub into the keyboard. This is accomplished by providing a wire extension between USB plug and port connector (4) within the cable (1). The extension wires lead directly from a port on the computer (7) to the port connector (4) on the keyboard. When a USB accessory or peripheral (6) is plugged into the port connector (4), a direct connection is established between the peripheral (6) and the actual USB port on the computer (7). As discussed above, USB 1.1 hubs are inexpensive, such that it is known in the art to build such hubs into a keyboard. On the other hand, USB 2.0 hubs are expensive and complicated, so that keyboard manufacturers avoid building USB 2.0 hubs into keyboards.

The improved cable of the present invention has many advantages over the prior art. The manufacturing cost is extremely low since no special electronics are required. The full power and speed of the source USB port (connected to plug (2)) is extended to the keyboard, be it USB 1.1 or USB 2.0. Future versions of USB will likely also function under this design, which is unlikely to be the case with a present-day hub design.

The many features and advantages of the invention are apparent from the detailed specification and, thus, it is intended by the appended claims to cover all such features and advantages of the invention that fall within the sphere and scope of the invention. Modifications and alternative embodiments will be apparent to a person of ordinary skill in the art. For example, the cable of the present invention can be used with other technologies that would otherwise require hubs (e.g. FireWire). Moreover, technologies can be mixed (e.g. a PS/2 keyboard with a USB extender).

Since numerous additional modifications and changes will readily occur to those skilled in the art, it is not desired to limit the invention to the exact construction and operation illustrated and described, and accordingly all suitable modifications and equivalents may be resorted to, falling within the scope of the invention.

1. A cable for connecting a keyboard and a peripheral device to a computer, comprising:
a first wire set connected at one end to keyboard electronics of said keyboard and having a first plug at an opposite end for connection to a first port on said computer; and
an extender wire set terminating at one end in a port connector incorporated into said keyboard and having a second plug at an opposite end for connection to a second port on said computer, such that upon connection of said peripheral device to said port connector a direct connection is established between said peripheral device and said second port on said computer.

2. The improved cable of claim 1, wherein said first and second plugs are USB plugs.

3. The improved cable of claim 1, wherein at least said first plug is a USB plug.

4. The improved cable of claim 1, wherein said first plug is a PS/2 plug.

5. The improved cable of claim 1, wherein said port connector is incorporated into said keyboard at a location separate from said one end of said first wire set.

6. The improved cable of claim 1, wherein said first wire set is connected at said one end to said keyboard electronics via a USB hub incorporated into said keyboard.
